(19) United States
(12) Patent Application Publication
(10) Pub. No.: US 2003/0202348 A1
(43) Pub. Date: Oct. 30, 2003

(54) Connecting unit for lamp string

(75) Inventor: Shwu-Miin Lin, Taipei (TW)

Correspondence Address: BRUCE H. TROXELL, SUITE 1404, 5205 LEESBURG PIKE, FALLS CHURCH, VA, 22041, US

(73) Assignee: Shining Blick Enterprises Co., Ltd.

(21) Appl. No.: 10/128,256

(22) Filed: Apr. 24, 2002

(51) Int. Cl. F21V 1/00

(52) U.S. Cl. 362/240; 362/249; 362/219

(57) ABSTRACT

A connecting unit for a lamp string, the connecting unit is a hollow connecting pipe made of transparent and flexible material, wherein each of the two ends of the connecting unit is provided therein with a connecting and positioning end to mate the diameter of a lamp holder of a lamp bulb, thereby, two mutually neighboring and confronting lamp bulbs of a lamp string are adapted to positioning in the connecting unit. With the connecting unit, a lamp string can be changed into some other type to thereby be more variable.

### BACKGROUND OF THE INVENTION

1. Field of the Invention

The present invention is related to a connecting unit for a lamp string, and especially to such a connecting unit capable of being used on a decorative lamp string to change the original type thereof.

2. Description of the Prior Art

Earlier conventional lamp strings, such as a Christmas lamp string, mostly are provided on conductors thereof with a lot of lamp bulbs separated mutually. Among the lamp bulbs, some mother lamp bulbs with inner twin metallic pieces are provided at locations with a predetermined interval, thereby, the entire lamp string is under control of the mother lamp bulbs to make intermittent shining after being electrically connected. However, such a conventional lamp string is overly monotonic. Such conventional lamp strings no more meet the requirement of the markets by the reason that the markets only need the effect of decoration when the lamp strings are hung on.

In the modern times, lamp strings have many variations, for example, the lamp bulbs and the conductors can be connected in the form of a net, such as is the case of U.S. Pat. No. 5,662,409, in order that the entire net light can be convenient for hanging to provide a function of planar flashing, and can be more convenient as well as faster for collecting for storage. However, such a net light or knitting light (such as is the case of U.S. Pat. No. 5,951,146) generally only has a single type, rather than has some variety.

### SUMMARY OF THE INVENTION

The object of the present invention is to provide a connecting unit for a lamp string, which unit is the connecting device of two mutually neighboring lamp bulbs, and thus can change the original type of a lamp string. For example, the structure is suitable especially to form a net light such as an icicle light.

To get the above object, the present invention is provided with a flexible connecting pipe made of plastic, each of the two ends of the connecting pipe is provided therein a connecting and positioning end mating the size of a lamp holder of a lamp bulb. In a preferred embodiment, the internal ends of the connecting pipe each has a knurled inner surface, so that two mutually neighboring lamp bulbs can be assembled in the connecting pipe, in this way, the original type of a lamp string can be changed.

The present invention will be apparent in its novelty and features after reading the detailed description of the preferred embodiment thereof in reference to the accompanying drawings.

### BRIEF DESCRIPTION OF THE DRAWINGS

FIG. 1 is a perspective view of a preferred embodiment of the present invention;

FIG. 2 is an analytic perspective view of the preferred embodiment of FIG. 1;

FIG. 3 is a partially enlarged sectional view of the connecting pipe taken from FIG. 2;

FIG. 4 is a longitudinal sectional view taken from FIG. 1;

FIG. 5 is a sectional view taken from the sectional line 5-5 of FIG. 4;

FIG. 6 is a sectional view showing another preferred embodiment of the connecting pipe of the present invention;

FIG. 7 is a schematic view showing an icicle light in a hanging state able to allow utilization of the present invention;

FIG. 8 is a schematic view showing a changed type from FIG. 7 with the connecting pipes of the present invention.

### DETAILED DESCRIPTION OF THE PREFERRED EMBODIMENT

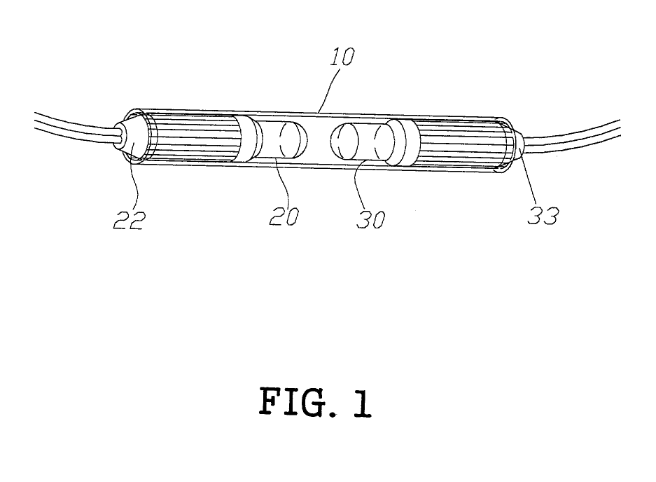

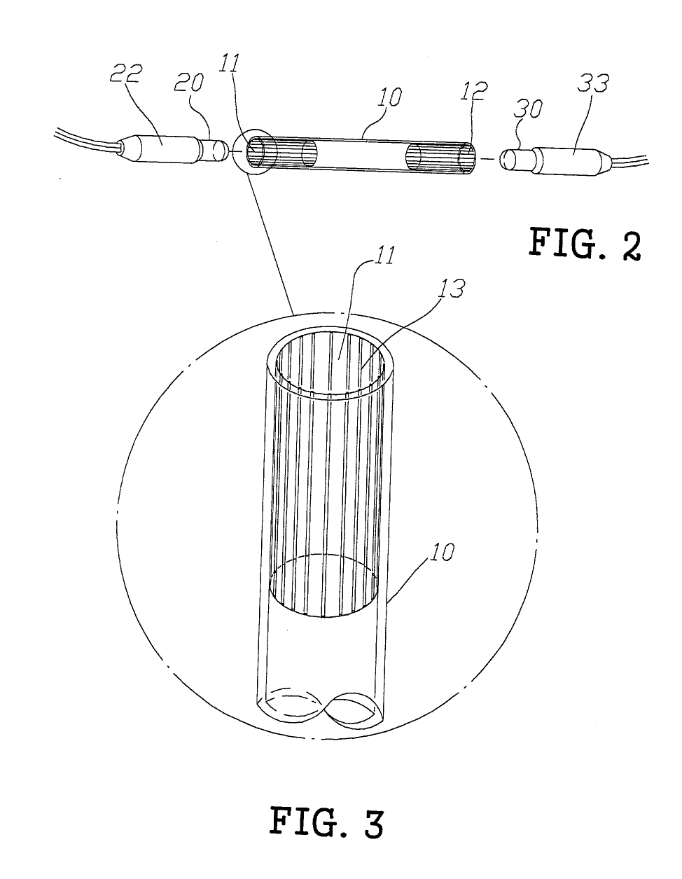

Referring to FIGS. 1 and 2, in this preferred embodiment, the present invention is provided with a connecting pipe 10 which is made of transparent and flexible material such as plastic, and can be assembled therein with two mutually neighboring lamp bulbs 20, 30 in opposition to each other.

As shown in FIGS. 2 and 3, each of the two ends of the connecting pipe 10 is provided therein a connecting and positioning end. In the preferred embodiment shown, the connecting pipe 10 is provided on the two inner ends thereof with an inner bore 11 and an inner bore 12 which are slightly smaller in diameter than a lamp holder 22 and a lamp holder 23 of the lamp bulb 20 and the lamp bulb 30 respectively. In this preferred embodiment, the inner bores 11, 12 each has a knurled inner surface 13 (referring to FIG. 3). The knurled inner surfaces 13 are extended inwardly of the end faces of the connecting pipe 10 each for a suitable length.

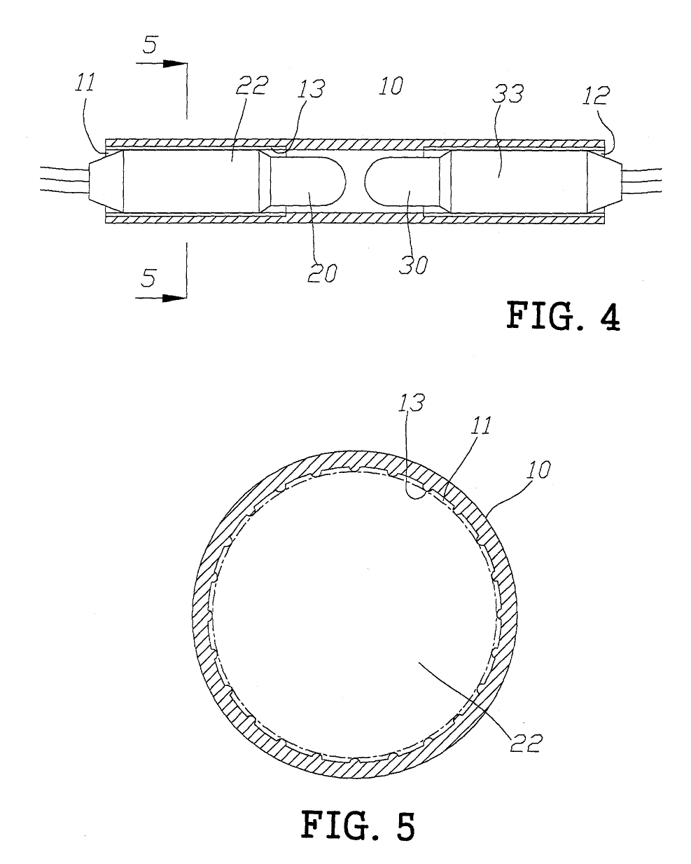

As shown in FIGS. 4 and 5, the connecting pipe 10 thereby can make positioning of the mutually neighboring lamp bulbs 20, 30 therein in opposition to each other by the friction force between the external walls of the lamp holders 22, 23 and the inner peripheral surfaces of the inner bores 11, 12 of the connecting pipe 10 as well as by the elastic binding force of the material itself when it is pressed during the lamp holders 22, 23 of the mutually neighboring lamp bulbs 20, 30 are insertion connected into the inner bores 11, 12.

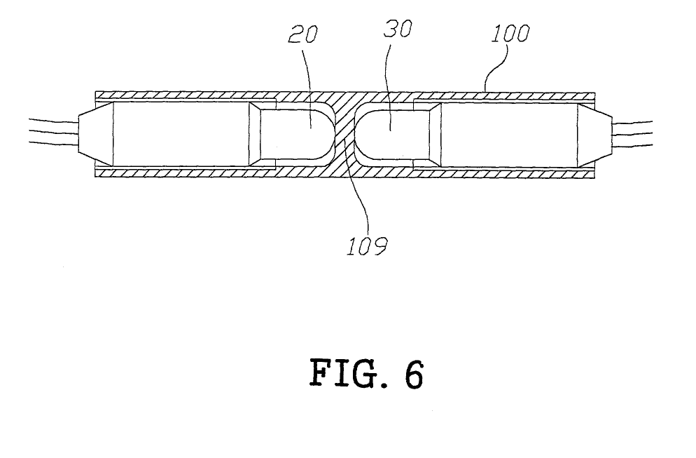

In another preferred embodiment of the present invention shown in FIG. 6, a connecting pipe 100 is provided at the middle thereof with a partition wall 109 to function as a positioning member during insertion connecting on the one hand, and to prevent the confronting lamp bulbs 20, 30 from direct abutting and damage on the other hand.

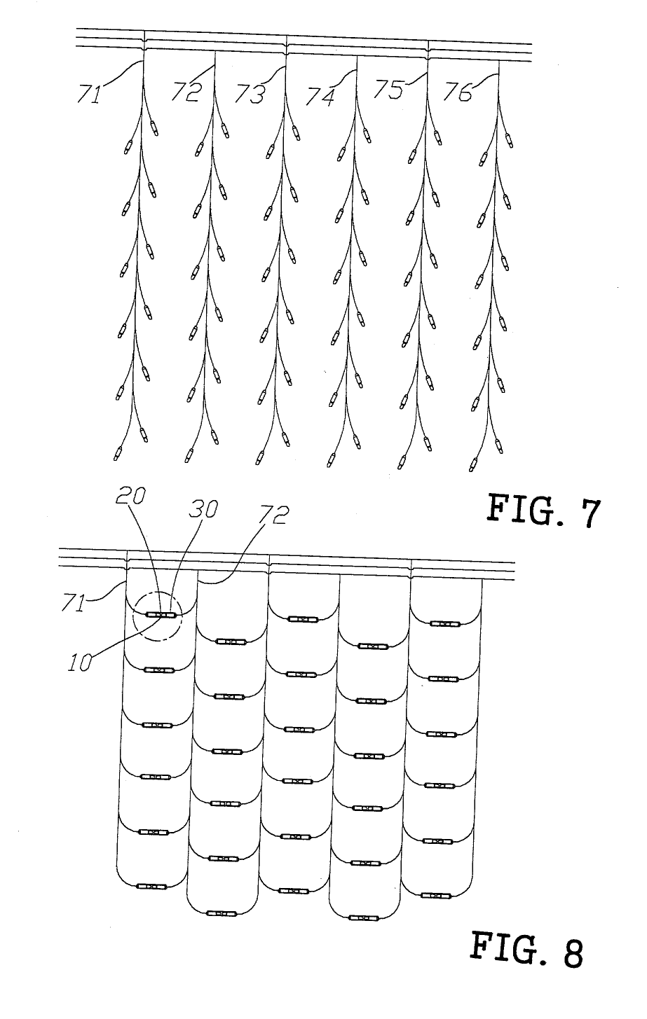

Referring to FIG. 7, in the icicle light shown, a plurality of lamp strings are pending in a mutual separate mode. There are shown six lamp strings 71, 72, 73, 74, 75 and 76 in the drawing. And as shown in FIG. 8, the icicle light of FIG. 7 can have its every two mutually neighboring lamp bulbs 20, 30 assembled in a connecting pipe 10 of the present invention, thereby, the entire icicle light can be changed into the net light as shown in FIG. 8.

Thereby, the present invention can render the lamp string only with a single function to be changed into a decorative net light; the effect of decoration thereby is richer and more variable.

The embodiments cited above are only for illustrating a preferred embodiment of the present invention. It will be apparent to those skilled in this art that various modifications or changes can be made to the elements of the present invention without departing from the spirit and scope of this invention. Accordingly, all such modifications and changes also fall within the scope of the appended claims.

1. A connecting unit for a lamp string, said connecting unit is a connecting pipe made of transparent and flexible material, wherein each of the two ends of said connecting unit is provided therein with a connecting and positioning end to mate the diameter of a lamp holder of a lamp bulb, thereby, two mutually neighboring and confronting lamp bulbs of a lamp string are adapted to positioning in said connecting unit.

2. The connecting unit as claimed in claim 1, wherein said connecting unit is provided between said two positioned and confronting lamp bulbs with a partition wall.

3. The connecting unit as claimed in claim 1 or 2, wherein said connecting and positioning ends in said connecting pipe are provided each with an inner bore, said inner bore has a knurled peripheral inner surface.
